(19) United States
(12) Patent Application Publication
(10) Pub. No.: US 2018/0005552 A1
(43) Pub. Date: Jan. 4, 2018

(54) APPAREL RACK

(71) Applicant: Wal-Mart Stores, Inc., Bentonville, AR (US)

(72) Inventors: Judy Lapp, Centeron, AR (US); Andrea Albright, Bentonville, AR (US)

(21) Appl. No.: 15/636,054

(22) Filed: Jun. 28, 2017

Related U.S. Application Data
(60) Provisional application No. 62/356,747, filed on Jun. 30, 2016.
(60) Provisional application No. 62/369,870, filed on Aug. 2, 2016.

(51) Int. Cl. G09F 7/10; A47F 7/24; G09F 23/00; A47F 5/10; G09F 21/00; G09F 7/18; A47F 5/00

(52) U.S. Cl. CPC G09F 7/10; G09F 21/00; A47F 7/24; G09F 7/18; G09F 23/00; A47F 5/108; A47F 2005/0075; G09F 2007/1843; G09F 2007/1856

(57) ABSTRACT

Disclosed is a fixture for the display and sale of apparel. The fixture includes an apparel rack and at least one sign panel coupled to the apparel rack. The at least one sign panel removeably and repeatably receives at least one sign. In some embodiments, the at least one sign panel removeably and repeatably receives more than one sign. The apparel rack is easy to set up, and the signs can be changed quickly and easily to match the prices or apparel being displayed that day or time. In one disclosed embodiment, the apparel rack is in the form of an H type rack with wing sign panels for the display and sale of apparel, such as intimate apparel. The sign panels allow for the fixture to display apparel and descriptive information in a concise manner with easy setup by a store associate.

### RELATED APPLICATIONS

This application claims priority to U.S. Provisional Patent Application Ser. No. 62/356,747, filed Jun. 30, 2016 and entitled “APPAREL RACK”, and claims priority to U.S. Provisional Patent Application Ser. No. 62/369,870, filed Aug. 2, 2016 and entitled “APPAREL RACK”, which are hereby incorporated entirely herein by reference.

### BACKGROUND OF THE INVENTION

### Technical Field

This invention relates to fixtures for displaying apparel, and particularly to an apparel rack with sign panels that have removeably signs.

### State of the Art

Apparel racks are used to display apparel for sale in retail stores. Apparel racks often have signs showing images related to the apparel being sold and marketing information such as prices associated with the apparel. It is desirable to be able to change the signage in a retail store often to keep up with apparel changes or with the changing prices of items, such as during a sale. Accordingly, it is desirable to have a fixture to display apparel that is easier to setup by a store associate, and easy to change the sign associated with the product on the apparel rack. It is also desirable to have a fixture to display apparel that has multiple signs that are easy to see and easy to change.

### BRIEF DESCRIPTION OF THE DRAWINGS

FIG. 1 shows a front perspective view of a fixture for displaying apparel;

FIG. 2 shows a top view of the fixture for displaying apparel of FIG. 1;

FIG. 3 shows the apparel rack of FIG. 1 with a sign being slid into a sign panel;

FIG. 4 shows a plurality of signs that can be used with the apparel rack of FIG. 1, and

FIG. 5 illustrates a method of displaying apparel.

### DETAILED DESCRIPTION OF EMBODIMENTS OF THE INVENTION

As discussed above, embodiments of the disclosed invention relate to fixtures for displaying apparel, and particularly to an apparel rack with sign panels that have removeably signs. Disclosed is a fixture for displaying apparel that includes an apparel rack and at least one sign panel coupled to the apparel rack. The at least one sign panel removeably and repeatably receives at least one sign. In some embodiments, the at least one sign panel removeably and repeatably receives more than one sign. The apparel rack is easy to set up, and the signs can be changed quickly and easily to match the prices or apparel being displayed that day or time. In one disclosed embodiment, the apparel rack is in the form of an H type rack with wing sign panels for the display and sale of apparel, such as intimate apparel. The sign panels allow for the fixture to display apparel and descriptive information in a concise manner with easy setup by a store associate.

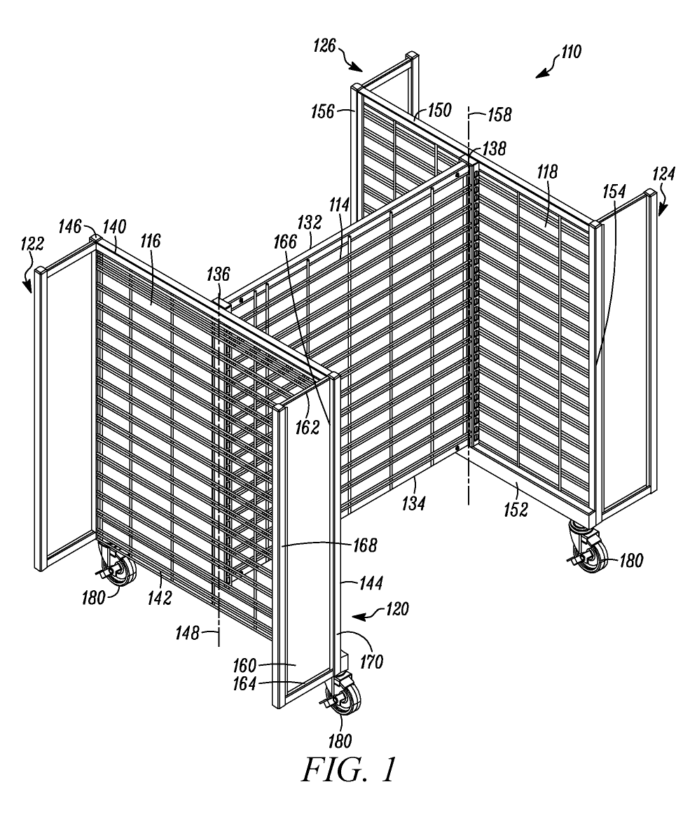

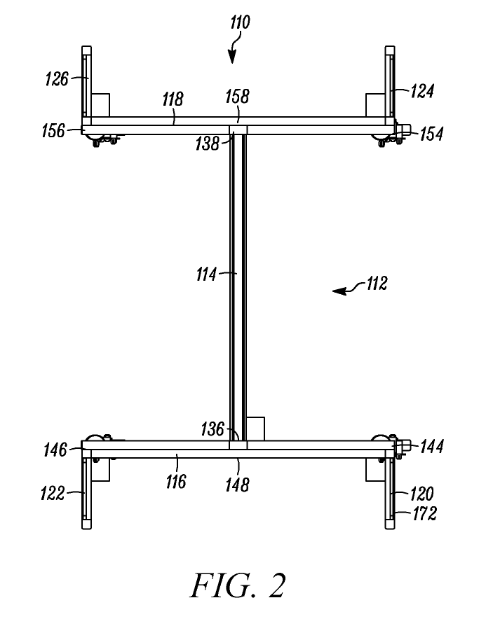

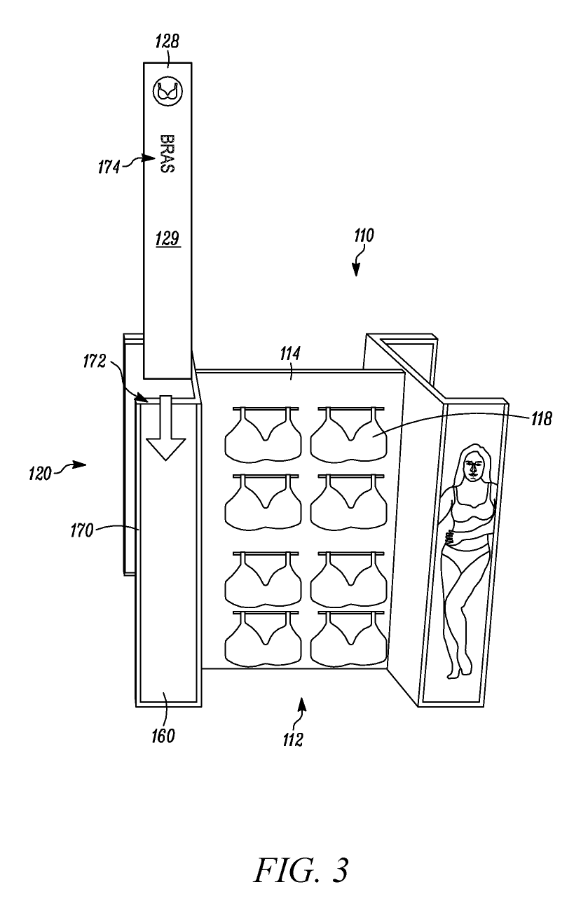

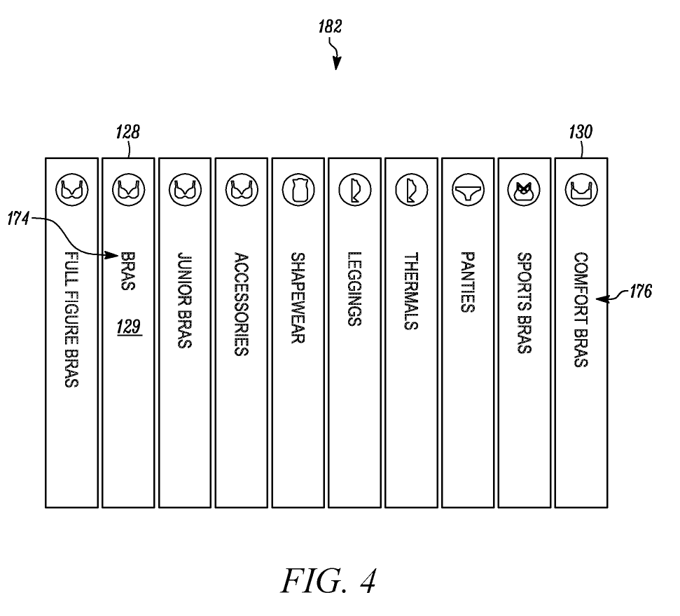

FIG. 1 through FIG. 4 show an embodiment of a fixture 110 for displaying apparel. FIG. 1 shows a front perspective view of fixture 110. FIG. 2 shows a top view of fixture 110. FIG. 3 shows a perspective view of fixture 110 with apparel hung on fixture 110, and showing a sign 128 being slid into a sign panel 120. FIG. 4 shows a plurality of signs 182 that can be removably inserted into sign panel 120.

Fixture 110 for displaying apparel includes an apparel rack 112 and at least one sign panel. In the embodiment shown in FIG. 1, apparel rack 112 includes a center panel 114, a first side panel 116 and a second side panel 118. First side panel 116 and second side panel 118 are each coupled to center panel 114. Fixture 110 in the embodiment shown in the figures includes a first sign panel 120, a second sign panel 122, a third sign panel 124, and a fourth sign panel 126, as shown in FIG. 1 and FIG. 2. Each of sign panels 120, 122, 124, and 126 removeably receives a sign such as sign 128 (FIG. 3) or any of plurality of signs 182 (FIG. 4). Sign 128 may have images on one side or both sides.

Apparel rack 112 is freestanding, and has an H-shape as can best be seen in FIG. 2. The rack may be made in modular form. Center panel 114 in this embodiment is rectangular and includes a center panel top edge 132, a center panel bottom edge 134, a center panel first side edge 136, and a center panel second side edge 138, as shown in FIG. 1. First and second side panels 116 and 118 are each coupled to center panel 114. First side panel 116 is coupled to center panel first side edge 136, and second side panel 118 is coupled to center panel second side edge 138.

First side panel 116 is rectangular in this embodiment and includes a first side panel top 140, a first side panel bottom 142, a first side panel first side edge 144, a first side panel second side edge 146, and a first side panel centerline 148. First side panel centerline 148 extends from first side panel bottom 142 to first side panel top 140 halfway between first side panel first side edge 144 and first side panel second side edge 146, as shown in FIG. 1. Center panel first side edge 136 is coupled to first side panel 116 along first side panel centerline 148 such that first side panel 116 is approximately perpendicular to center panel 114.

Second side panel 118 is rectangular in this embodiment and includes a second side panel top 150, a second side panel bottom 152, a second side panel first side edge 154, a second side panel second side edge 156, and a second side panel centerline 158. Second side panel centerline 158 extends from second side panel bottom 152 to second side panel top 150 halfway between second side panel first side edge 154 and second side panel second side edge 156, as shown in FIG. 1. Center panel second side edge 138 is coupled to second side panel 118 along second side panel centerline 158 such that second side panel 118 is approximately perpendicular to center panel 114.

All surfaces of center panel 114 and side panels 116 and 118 may be used for displaying apparel, particularly for hanging apparel. The apparel may be any apparel, such as intimate apparel. Center panel 114 and side panels 116 and 118 are formed of a metal grid in this embodiment for easy hanging of hooks and bars for hanging apparel. In some embodiments, center panel 114 and side panels 116 and 118 are formed of a grid of other rigid material. In some embodiments, center panel 114 and side panels 116 and 118 are formed of a solid metal or other rigid material such as wood or plastic.

Conventional fastening or coupling means may be used to connect center panel 114 and side panels 116 and 118.

Each one of sign panels 120, 122, 124, and 126 are coupled to an edge of a side panel 116 or 118, as shown in FIG. 1 and FIG. 2. Each one of sign panels 120, 122, 124, and 126 are coupled approximately perpendicularly to an edge of a side panel 116 or 118 in this embodiment, but this is not meant to be limiting. First sign panel 120 is coupled to first side panel first side edge 144 such that first sign panel 120 is approximately perpendicular to first side panel 116, as can best be seen in FIG. 2.

Second sign panel 122 is coupled to first side panel second side edge 144 such that second sign panel 122 is approximately perpendicular to first side panel 116, as can best be seen in FIG. 2. Third sign panel 124 is coupled to second side panel first side edge 154 such that third sign panel 124 is approximately perpendicular to second side panel 118, as can best be seen in FIG. 2. Similarly, fourth sign panel 126 is coupled to second side panel second side edge 156 such that fourth sign panel 126 is approximately perpendicular to second side panel 118, as can best be seen in FIG. 2. Each one of sign panels 120, 122, 124, and 126 removeably receives a sign such as sign 128 (FIG. 3 and FIG. 4) or any of plurality of signs 182 (FIG. 4).

Each sign panel includes a backpanel bounded on three sides by a frame, and an opening on the fourth side that receives the sign such as sign 128 as shown in FIG. 3. For example, first sign panel 120 includes a backpanel 160 with four backpanel edges, backpanel top edge 162, backpanel bottom edge 164, backpanel first side edge 166, and backpanel second side edge 168. Backpanel 160 is bounded by a frame 170 on three edges, in this embodiment bottom edge 164, and first and second side edges 166 and 168. Backpanel top edge 162 includes an opening 172 for receiving a sign 128 as shown in FIG. 3. Sign 128 sides through opening 172 into frame 170 from backpanel top edge 162 to backpanel bottom edge 168. Sign 128 is held against backpanel 160 by frame 170. Frame 170 holds sign 128 against backpanel 160 such that an image 174 on sign front surface 129 is visible to shoppers, as shown in FIG. 3.

Sign 128 removeably slides into frame 170 so that sign 128 can be easily changed for a different sign. If it is desired, for example, to change fixture 110 so that image 174 of sign 128 is replaced by image 176 of sign 130 (see FIG. 4), then sign 128 can be slid out of frame 170 and sign 130 can be slid in frame 170 so that image 174 is visible to shoppers. In some embodiments, frame 170 holds more than one sign 128 or 130, so that the desired image can be moved to the outside and other signs stored behind the outer one. FIG. 4 shows an example of a plurality of signs 182 and examples of the different images that can be displayed by fixture 110 by using different signs in frame 170. Any of plurality of signs 182 can be slid into frame 170 to be displayed. Similarly sign panels 122, 124, and 126 have backpanels and frames for removeably receiving any one or more of plurality of signs 182.

In this embodiment, fixture 110 includes wheels 180 for ease of moving fixture 110, but this is not meant to be limiting. Fixture 110 can have other types of feet, or sit directly on the ground in some embodiments.

Fixture 110 allows any one or more of plurality of signs 182 (for example) to be quickly and easily inserted in a sign panel 120, for example, and to be easily removed from sign panel 120. It is to be understood that plurality of signs 182 are examples only and many different types of signs can be used. The signs may be doubled in the sign frame.

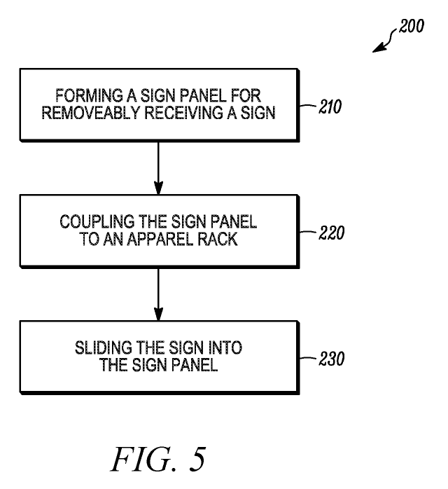

FIG. 5 illustrates a method 200 of displaying apparel on a fixture. The method includes an act 210 of forming a sign panel for removeably receiving a sign. Method 200 also includes an act 220 of coupling the sign panel to an apparel rack, and an act 230 of sliding the sign into the sign panel. In some embodiments, method 200 includes removing the sign from the sign panel, where the sign is a first sign, and sliding a second sign into the sign panel. In some embodiments, the sign is a first sign, and method 200 also includes sliding a second sign into the sign panel in front of the first sign such that a first image on the first sign is not visible, and a second image on the second sign is visible.

In some embodiments, act 210 of forming the sign panel includes forming a backpanel, and bounding the backpanel on three sides of the backpanel with a frame, leaving an opening for receiving the sign on a fourth side of the backpanel.

In some embodiments, method 200 includes forming the apparel rack, where forming the apparel rack comprises coupling at least one side panel to a center panel, coupling the sign panel to the at least one side panel, and hanging apparel on a front and back surface of the center panel of the fixture. In some embodiments, method 200 includes hanging apparel on the at least one side panel.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above.

1. A fixture for displaying apparel comprising:
a center panel;
a first and a second side panel, wherein each of the first and the second side panels are coupled to the center panel; and
at least one sign panel coupled to one of the first or the second side panels, wherein the at least one sign panel removeably receives a sign.

2. The fixture of claim 1, wherein the center panel is rectangular and comprises a center panel first side edge and a center panel second side edge and wherein the first side panel is coupled to the center panel first side edge, and the second side panel is coupled to the center panel second side edge.

3. The fixture of claim 2, wherein the first side panel is rectangular and comprises a first side panel first side edge, a first side panel centerline, and a first side panel second side edge, and wherein the first side panel is coupled to the center panel first side edge along the first side panel centerline such that the first side panel is perpendicular to the center panel.

4. The fixture of claim 3, wherein the at least one sign panel comprises a first and a second sign panel, wherein the first sign panel is coupled to the first side panel first side edge such that the first sign panel is approximately perpendicular to the first side panel, and wherein the second sign panel is coupled to the first side panel second side edge such that the second sign panel is approximately perpendicular to the first side panel.

5. The fixture of claim 4, wherein the first sign panel comprise a backpanel comprising four backpanel edges, wherein the backpanel is bounded by a frame on three of the four backpanel edges, and wherein the fourth backpanel edge comprises an opening for receiving the sign.

6. The fixture of claim 5, wherein the sign slides into the frame through the opening such that the frame holds the sign against the backpanel and an image on a sign front surface is visible.

7. The fixture of claim 6, wherein the sign removeably slides into the frame.

8. The fixture of claim 7, wherein the opening is along a top edge of the first sign panel.

9. The fixture of claim 1, wherein the fixture comprises at least one wheel.

10. The fixture of claim 9, wherein the fixture comprises four wheels.

11. The fixture of claim 1, wherein the center panel is a grid.

12. The fixture of claim 1, wherein the two side panels are grids.

13. A method of displaying apparel on a fixture comprising:
forming a sign panel for removeably receiving a sign;
coupling the sign panel to an apparel rack; and
sliding the sign into the sign panel.

14. The method of claim 13, further comprising:
removing the sign from the sign panel, wherein the sign is a first sign; and
sliding a second sign into the sign panel.

15. The method of claim 13, wherein the sign is a first sign, and further comprising sliding a second sign into the sign panel in front of the first sign such that a first image on the first sign is not visible, and a second image on the second sign is visible.

16. The method of claim 13, wherein forming the sign panel comprises:
forming a backpanel; and
bounding the backpanel on three sides of the backpanel with a frame, leaving an opening for receiving the sign on a fourth side of the backpanel.

17. The method of claim 13, further comprising forming the apparel rack, wherein forming the apparel rack comprises:
coupling at least one side panel to a center panel;
coupling the sign panel to the at least one side panel; and
hanging apparel on a front and back surface of the center panel of the fixture.

18. The method of claim 17, further comprising hanging apparel on the at least one side panel.
